(19) United States
(12) Patent Application Publication
(10) Pub. No.: US 2003/0126032 A1
(43) Pub. Date: Jul. 3, 2003

(54) Upload ordering system

(75) Inventors: Charles Edward Coode, Surrey (GB); Mohamed Azweem Karimullah, London (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: GENERAL ELECTRIC COMPANY, Schenectady, NY (US)

(21) Appl. No.: 10/184,869

(22) Filed: Jun. 28, 2002

(30) Foreign Application Priority Data
Jun. 28, 2001 (GB) GB 0115886.4

(51) Int. Cl. G06F 17/60

(52) U.S. Cl. 705/26; 705/1

(57) ABSTRACT

An ordering system for upload ordering over the internet comprises a file server for receiving an upload order, an application server programmed to receive the upload order from the file server and a database server programmed to store details of customers authorized to produce upload orders. The application server is programmed to check the customer's authority to provide an upload order, to check the order details against the customer details in the database server and, if correct, pass on the order to the supplier.

### BACKGROUND OF THE INVENTION

This invention relates to an upload ordering system for use with the internet.

A system exists, known as EDI (Electronic Data Interchange), in which customers can place orders with suppliers automatically once a purchase order has been raised. This system uses a special network which takes the customer's order from the customers computer and sends it directly to the supplier's ordering system, often overnight. The next day, the supplier's ordering system relays back to the customer details of the order, the cost and the delivery date of the order.

This system works well for large customers who make large and complicated orders, but is an expensive system both to use and implement and does not permit of orders being made in real time.

### SUMMARY OF THE INVENTION

The present invention seeks to provide an upload ordering system which is relatively easy to implement and which enables real time ordering.

According to a first aspect of the invention, there is provided an ordering system for upload ordering over the internet comprising a file server for receiving an upload order, an application server programmed to receive the upload order from the file server, a database server programmed to store details of customers authorized to produce upload orders, the application server being programmed to check the customer's authority to provide an upload order, to check the order details against the customer details in the database server and, if correct, pass on the order to the supplier.

Preferably the database server is programmed to store the customer's identity and the format of the order.

The database server may be programmed to store the product identification format of the order.

The application server is programmed to convert to a standard format all orders that are of a format stored in the database server but not in that standard format.

The system may further comprise a customer computer programmed to record orders in the customer's format and to produce, for each order which is to be uploaded, an information or flat file in a format suitable for receipt by the application server.

### BRIEF DESCRIPTION OF DRAWINGS

The invention will now be described in greater detail, by way of example with reference to the drawings.

FIG. 1 is flow diagram of one embodiment of the ordering process of the system in accordance with the invention.

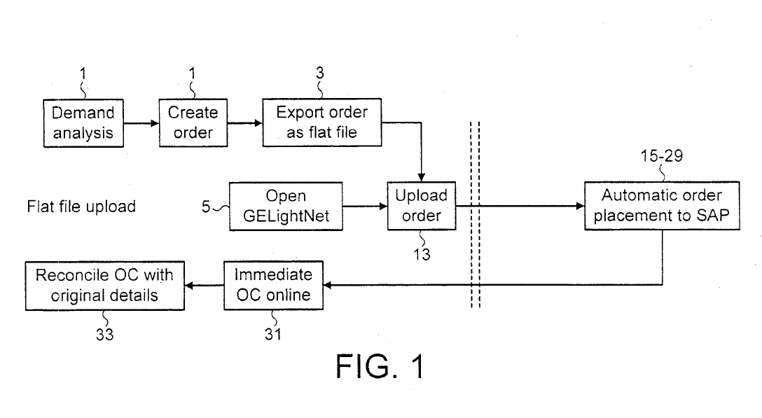

FIG. 2 is a more detailed flow chart of the uploading operation of the ordering process of FIG. 1.

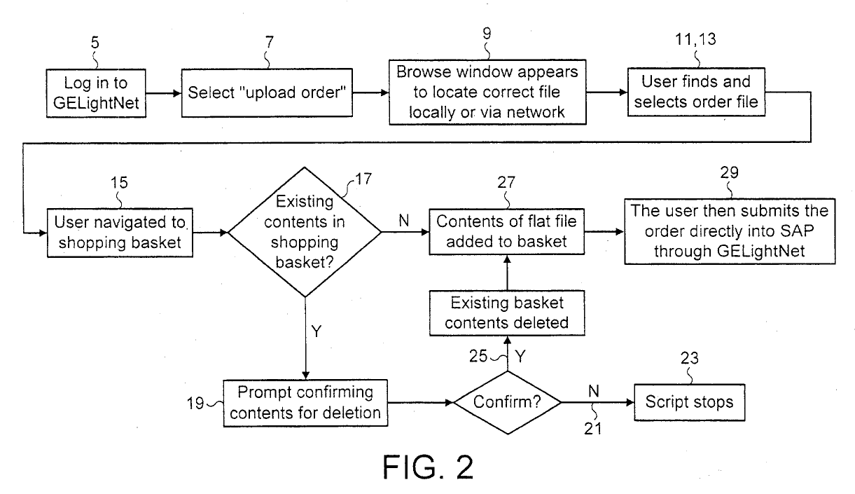

### DETAILED DESCRIPTION

In one embodiment, the upload order system enables allows users of a Customer Web Centre (CWC) to upload orders into the application directly from their ordering system or their own PC. In order to use the facility, users must have the capability to export an order as an information or flat file for subsequent upload in to the web-based Customer Web Centre. This file is generated from the customer's back-end database. The Customer Web Centre allows the customer to select the file containing the order, which is then verified and validated, with respect to its content, and then uploaded into a shopping basket. Then the customer can check the order to confirm that its details are correct and can then submit it directly in to the supplier's ERP (Enterprise Resource Planning) in real-time.

To this end, the CWC comprises a web server which provides the interface between the customer and supplier, an application server which contains the coding for operating the order system and retains the order during processing prior to submission to the suppliers and a database server which contains the customer's details and also product details extracted from the supplier's own back end system.

Referring now to the drawings, in order to operate the system, the operation proceeds as follows.

1. The customer first creates (1) and order on its own system.

2. The order is then exported (3) as an information or flat file to a storage location of the customer's choice (e.g. floppy disc, hard drive or network server).

3. The customer then logs (5) in to the CWC through the web server giving user name and password. This is checked by the application server against the customer's details stored in the database server and if the stored details are present, an authorization flag is set.

4. The customer then navigates to an Order Entry screen and, if the authorization flag is set, an “Upload Order” button will be visible on this screen.

5. The customer clicks (7) on this button and is presented with a small “Browse” window (9) allowing him to locate(11) the exported order file at its storage location. This file is selected and can be uploaded by clicking on an “Upload” button.

6. The file is then submitted to the application server where it is read and stored in a string buffer.

7. The file is validated for basic errors (e.g. compulsory fields not being present, presence of non-numeric data in numeric fields, etc.).

8. If the file passes through these validations, all the data in the file is converted into the supplier's standard format and put into a session variable and control is passed to the order entry screen to enable the order to be added to a “shopping basket” (15). If, on the other hand, it does not pass these validations, an error message is generated and further processing ceases.

9. If the order entry screen already contains any items (17), the customer is prompted (19) to decide whether he wants the items to be deleted or not. In case he decided he does not (21), then processing stops there (23). If he decides to delete all items (25), then the current order (originally contained in the file) and held in a session variable is inserted (27) into the basket.

10. Once the user decides that the contents of the basket are correct, the order is submitted (29) to the supplier.

11. An immediate order conformation is supplied to the customer (31) enabling him to reconcile the confirmed order with the original details(33).

The technical elements of this embodiment of the invention will now be discussed.

As with most applications, it is to be expected that the application server will be hosted by a professional hosting service provider. As a security measure the hosting server does not allow any file that is not actually related to this application to be placed on the application server proper. Also, it does not allow any files to be created on the server proper during the running of the application. Thus, the application uploads the file, but does not physically place it on the server proper. To get around this the file, read from the client machine, is placed into a buffer on the server before it is validated. Later, the contents of this buffer are placed into a session variable and inserted into the shopping basket.

Customers have their own order format and these formats will differ from customer to customer Thus, the application should be generalized so as to accommodate as many customer order formats as possible. Theoretically the application could be used with any format that the customer wanted to create in its order file, but, in order to manage the scope and administrative overhead of different formats it is economical to allow the application to view a limited number of formats, for example:

Excel (.csv) based file

Txt file

EDI format file

XML file

Selected, widely used system types of significant number of the customer base

Each of these formats has to be read and converted into a standard format. In order to accommodate this, a table is created in the database server. This table contains the customer ID, the Selling Company, the Product Type and the file format (one of the above list) of the file to be uploaded.

In this embodiment, a table (eucwc.cust_ord_fmt) is created in the database, containing the following fields.

| Name | Null? | Type |
|---|---|---|
| CD_CUST | NOT NULL | VARCHAR2(8) |
| CD_CO_SELL | NOT NULL | VARCHAR2(2) |
| CD_PROD_TYP_ID | NOT NULL | VARCHAR2(1) |
| CD_FORMAT_FILE | NOT NULL | VARCHAR2(50) |

The fields CD_CUST (customer ID) and CD_CO_SELL (the customer selling company) together form the primary key of the table.

The CD_PROD_TYP_ID field consists of the product type. The product type must be same as the product type given in the file that the customer is uploading. Thus, for example, the product type may be the supplier's part no. or the customer's part no.

The field CD_FORMAT_FILE is the format of the file the customer is uploading. This field may consist of any format which has been agreed between the customer and the supplier.

The display of “Upload Order” button on Order Entry Page is controlled by a program gomssapcountry.jsp. When the customer logs in to the application,—gomssapcountry.jsp checks against the eucwc.cust_ord_fmt table as to whether there are corresponding values for Customer Code (CD_CUST) and Selling Company (CD_CO_SELL).

If there are entries in these fields, a flag will be set and then stored in the session variable indicating that the customer should have the “Upload Order” button available in the Order Entry screen. When the customer navigates to the—gomsorderentryl.jsp page, the flag in the session variable is checked and the “Upload Order” button is displayed or hidden according to whether or not the flag is set.

Application files which are used or affected during the application will now be discussed.

1. eucwcupload.jsp: This file is opened when the user clicks on the “Upload Order” menu option. This file opens in the form of a “child” window. It consists of a browse box, where the user chooses the file to be uploaded. Once the user chooses the file he wants to upload, there are two buttons visible, “Upload” and “Cancel”. If the user chooses to upload, then the file is submitted to a servlet (2 below).

2. UploadFiles.java: This file is a servlet to which the file that the user chooses is submitted. This servlet performs the following functions:.

a. It gets the client's account id and the selling company from the session variable. Using this, it gets the client's format from the database. If there is no format available for the client it redirects to the upload child window with the appropriate error message.

b. It gets the customer'” product type from the database depending on the format and its selling company and account id. If there is no product type mentioned in the database, then again it redirects to the child window with an error message.

c. If both the above parameters are found from the database, then the servlet goes ahead with actually reading the file and validating it. The servlet uses the files mentioned below to perform these actions.

d. Once all validations are performed, the data returned after validation is put into an array. This array is then put into a session variable and control is transferred to the child window. The child window, in turn, transfers control to the order entry page.

3. MultipartRequest.java, MultipartInputStreamHandler.java: These files perform the function of actually reading the data that has been uploaded. The file is read from the input stream and converted into the required format. It is then put into a string buffer.

4. ValidateAndCreateGEFile.java: This file performs the function of validating all the data that is returned from the above files. This file validates data depending on the format of the customer and the product type, both of which are retrieved from the database in UploadFiles.java. This file returns data to UploadFiles.java in the standard format so that it can be put into a session variable. In case any errors are found during validation, these are returned to UploadFiles.java. These errors then get displayed in the child window and further processing is not done.

5. gomsorderentryl.jsp: This is the order entry page which is used to display the order to the user and also perform any operations with the order, like checking it, submitting it, deleting any items, adding more items, etc. This file is manipulated so as to check if the session variable indicating whether the user has uploaded any file is present. If it is and if the existing basket has any items, the user is alerted and prompted that any existing items will be deleted from the basket. If the user agrees, then all existing items are deleted and the contents from the session are inserted into the basket. If there are no existing items present then the items are added into the basket immediately.

6. gomsordentjscriptl.inc, gomsordentmethodsl.inc: These files are part of the gomsorderentryl.jsp and contain the functions which are called in the order entry page. The first file contains all the java script functions that are required and the second file contains the java functions that are to be called on the server. These files had to be modified to include the functions that would change during uploading.

Examples of formats suitable for use in the invention are a so called “Kerridge” format or a suitable “Standard” format.

In case the customer has the format “kerridge”, the file that he uploads will be of the format shown below.

“PO|ProdNum|ProdDesc|ProdType|Date|Qty”

eg:

19169 “35109”,“LU50/85/HO/T27”,“SA”,“20010506”, 500

19169, “10101”,“LU70/90/D/27”,“SA”,“2001 0503”, 504

Here, each element in the string indicates the order in which the elements occur in the file. The first column in the file will contain the PO Number, the second column will contain the Product Number and so on. The application is capable of handling any format, which is similar to this format, with the columns interchanged.

The second kind of format handled is the supplier's “Standard”. This format is of the kind given below.

HEA,123456,SA,20010410

ITM,35109,20,20010510

ITM,35112,20,20010510

ITM,35112,20,20010510

END

This format contains the items in a specific format like the header items in the “HEA” tag, all the items with the “ITM” tag, etc.

It will be appreciated that various additions to or modifications of the above described embodiment may be made within the scope of the invention. For example various types of data formats have been described an in particular, one proposed form of supplier's standard format has been given. The standard format used by the supplier will of course depend on the supplier's existing standard format if such a format is present. It is equally to be understood that the customer may want to deal with a number of supplier's in the same way although the individual suppliers may have different standard formats. With the present invention, each supplier would have its own web page and servers which would convert the various customer formats into their own particular standard format thus making the invention universal in operation.

1. An ordering system for upload ordering over the internet comprising a file server for receiving an upload order, an application server programmed to receive the upload order from the file server, a database server programmed to store details of customers authorized to produce upload orders, the application server being programmed to check the customer's authority to provide an upload order, to check the order details against the customer details in the database server and, if correct, pass on the order to the supplier.

2. A system as claimed in claim 1, wherein the database server is programmed to store the customer's identity and the format of the order.

3. A system as claimed in claim 2, wherein the database server is programmed to store the product identification format of the order.

4. A system as claimed in claim 2, wherein the application server is programmed to convert to a standard format all orders that are of a format stored in the database server but not in that standard format.

5. A system as claimed in claim 3, wherein the application server is programmed to convert to a standard format all orders that are of a format stored in the database server but not in that standard format.

6. A system as claimed in claim 1 and comprising a customer computer programmed to record orders in the customer's format and to produce, for each order which is to be uploaded, a flat file in a format suitable for receipt by the application server.

7. A system as claimed in claim 2 and comprising a customer computer programmed to record orders in the customer's format and to produce, for each order which is to be uploaded, a flat file in a format suitable for receipt by the application server.
